(19) United States
(12) Patent Application Publication
(10) Pub. No.: US 2018/0062174 A1
(43) Pub. Date: Mar. 1, 2018

(54) NONAQUEOUS ELECTROLYTIC SOLUTION STORAGE ELEMENT

(71) Applicants: Shuhei TAKESHITA, Shizuoka (JP); Naoto ABE, Shizuoka (JP); Yoshio ITOH, Shizuoka (JP); Tatsuya DAN, Shizuoka (JP); Yuka ARAKI, Shizuoka (JP)

(72) Inventors: Shuhei TAKESHITA, Shizuoka (JP); Naoto ABE, Shizuoka (JP); Yoshio ITOH, Shizuoka (JP); Tatsuya DAN, Shizuoka (JP); Yuka ARAKI, Shizuoka (JP)

(21) Appl. No.: 15/670,172

(22) Filed: Aug. 7, 2017

(30) Foreign Application Priority Data
Aug. 26, 2016 (JP) 2016-165781

(51) Int. Cl. H01M 4/587; H01M 10/054; H01M 10/0568

(52) U.S. Cl. CPC H01M 4/587; H01M 2004/027; H01M 10/0568; H01M 10/054

(57) ABSTRACT

A nonaqueous electrolytic solution storage element is provided. The nonaqueous electrolytic solution storage element includes a cathode containing a cathode active material, an anode containing an anode active material to which sodium ion is insertable and from which the sodium ion is separable, and a nonaqueous electrolytic solution. The anode active material comprises a porous carbon having a plurality of pores forming a three-dimensional network structure, and the porous carbon has crystallinity.

### CROSS-REFERENCE TO RELATED APPLICATIONS

This patent application is based on and claims priority pursuant to 35 U.S.C. § 119(a) to Japanese Patent Application No. 2016-165781, filed on Aug. 26, 2016, in the Japan Patent Office, the entire disclosure of which is hereby incorporated by reference herein.

### BACKGROUND

### Technical Field

The present disclosure relates to a nonaqueous electrolytic solution storage element.

### Description of the Related Art

In recent attempts to achieve downsizing of mobile devices or to put fuel cell vehicles into practical application, nonaqueous electrolytic solution storage elements that have a high energy density, such as lithium-ion secondary batteries, have been rapidly developed.

Lithium used as a material for lithium-ion secondary batteries is a limited natural resource, and areas where lithium can be mined are unevenly distributed on the earth. In view of this situation, sodium is attracting attention as a battery material for its abundance. For low cost and stable supply, sodium-ion secondary batteries are now under development toward practical application.

Since sodium ion has a large ionic radius, it is not easy to intercalate sodium ion into between graphite layers. Even if sodium ion is successfully intercalated, the crystal structure of graphite will get distorted. As a result, the graphite layers become unable to reversibly expand and contract, thereby collapsing the crystal structure of graphite without giving a capacity.

### SUMMARY

In accordance with some embodiments of the present invention, a nonaqueous electrolytic solution storage element is provided. The nonaqueous electrolytic solution storage element includes a cathode containing a cathode active material, an anode containing an anode active material to which sodium ion is insertable and from which the sodium ion is separable, and a nonaqueous electrolytic solution. The anode active material comprises a porous carbon having a plurality of pores forming a three-dimensional network structure, and the porous carbon has crystallinity.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic cross-sectional view of an anode active material for use in an anode of a nonaqueous electrolytic solution storage element according to an embodiment of the present invention;

FIG. 2 is a schematic view of a nonaqueous electrolytic solution storage element according to an embodiment of the present invention;

FIG. 3 is a schematic view of a nonaqueous electrolytic solution storage element according to another embodiment of the present invention;

FIG. 4 is a graph showing X-ray diffraction spectra of carbons A and K;

FIG. 5 is a graph showing a discharge curve obtained in Example 11;

FIG. 6 is a graph showing a discharge curve obtained in Example 13, and

FIG. 7 is a graph showing a discharge curve obtained in Comparative Example 5.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

In accordance with sonic embodiments of the present invention, a nonaquenus electrolytic solution storage element is provided capable of occluding sodium ion in large amounts to provide a high capacity.

### Nonaqueous Electrolytic Solution Storage Element

A nonaqueous electrolytic solution storage element according to an embodiment of the present invention includes: a cathode containing a cathode active material; an anode containing an anode active material to which sodium ion is insertable and from which the sodium ion is separable; and a nonaqueous electrolytic solution.

The anode active material comprises a porous carbon having a plurality of pores forming a three-dimensional network structure. The porous carbon has crystallinity, The nonaqueous electrolytic solution storage element may optionally include other members, if needed.

Graphite is conventionally used as an anode active material for lithium-ion batteries. In attempting to use graphite as an anode active material for sodium-ion batteries, because the size of sodium ion is greater than the interlayer distance (d=0.335 nm) of graphite, the crystal structure of graphite cannot follow insertion or separation of sodium ion and thereby collapses. Collapse of the graphite crystal structure means collapse of the anode active material, which results in impossibility of insertion of sodium ion and development of capacity. Accordingly, graphite materials have not been used as anode active materials for sodium-ion secondary batteries.

In addition, there has been an attempt to use carbonaceous materials, such as poorly-graphitizable carbon particles having pores that are larger in size than sodium ion and capable of adsorbing and storing sodium ion, present at the surface or inside thereof. However, such materials have a limit on capacity obtained by adsorption of sodium ion, which is far inferior to the ideal capacity 372 mAh/g that is obtained when lithium ion is intercalated into between graphite carbons layers.

The present invention is achieved based on the finding that graphite and carbonaceous materials as anode active materials cannot give a high capacity to sodium-ion batteries, because the crystal structures thereof collapse and only a limited amount of sodium ion can be stored therein in response to intercalation of sodium ion.

The nonaqueous electrolytic solution storage element according to an embodiment of the present invention uses an anode active material having an interlayer distance greater than that of typical graphite, which is easy to insert sodium ion. The anode active material also absorbs expansion of the interlayer spaces occurring in response to intercalation of sodium ion, due to the presence of pores formed in a three-dimensional network structure, thereby being suppressed from collapsing.

Thus, the nonaqueous electrolytic solution storage element can occlude sodium ion in large amounts, thus providing a high capacity.

Details of each constitutional element of the nonaqueous electrolytic solution storage element are described below.

### Anode

The anode has no limit so long as an anode active material is contained therein. For example, the anode may comprise an anode collector and an anode material, containing the anode active material, disposed on the anode collector.

The anode is not limited in shape and may be in a plate-like or sheet-like shape.

### Anode Material

The anode material has no limit so long as the anode active material to/from which sodium ion is insertable/separable is contained therein. The anode material may further contain a binder, a thickener, and/or a conductive auxiliary agent.

### Anode Active Material

The anode active material comprises a porous carbon having a plurality of pores forming a three-dimensional network structure. The porous carbon is a crystalline carbon having crystallinity.

The porous carbon “having a plurality of pores forming a three-dimensional network structure” refers to a state in which each porous carbon particle has multiple pores at the surface and inside thereof while adjacent pores being three-dimensionally connected to each other to form communicating pores opened at the surface of the particle.

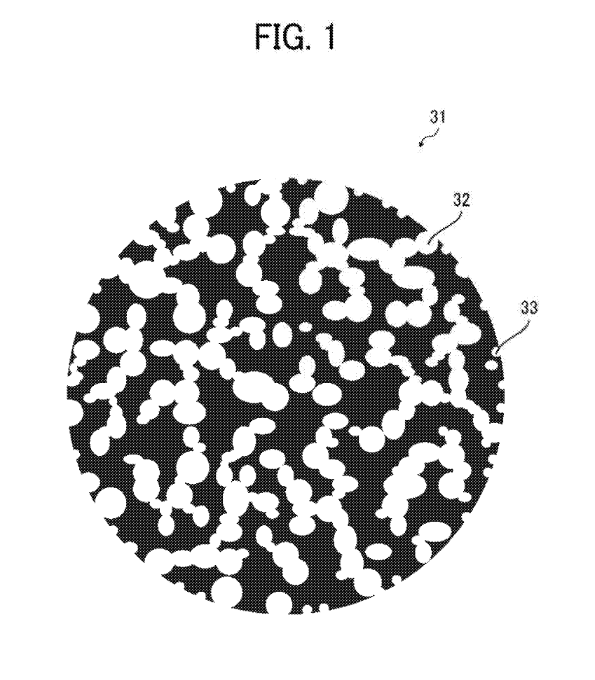

Whether the anode active material has a plurality of pores forming a three-dimensional network structure or not can be determined by, for example, observing the anode active material by scanning electron microscope (SEM) or transmission electron microscope (TEM). A schematic cross-sectional image of the anode active material having a plurality of pores forming a three-dimensional network structure, obtained by TEM observation, is illustrated in FIG. 1.

The porous carbon “having crystallinity” refers to a state in which hexagonal plate-like monocrystal layers (graphite layers), in which carbons are bonded via sp² hybridized orbitals, are stacked. Whether the anode active material has crystallinity or not can be determined by, for example, observing the anode active material by TEM to confirm the layered structure of graphite or detecting X-ray diffraction spectrum peaks.

As the anode active material has a plurality of pores forming a three-dimensional network structure, expansion of the graphite layers occurring in response to intercalation of sodium ion into the graphite layers is absorbed, which is advantageous in terms of smooth occlusion and release of sodium ion.

The pores in the anode active material may include either micropores each having a minimum pore diameter less than 2 nm or mesopores each having a minimum pore diameter of from 2 to 50 nm. Preferably, the pores forming a three-dimensional network structure in the anode active material are mesopores. When the pores in the anode active material are mesopores, advantageously, sodium ion can be easily migrate to and occluded in the mesopores because the minimum pore diameter of each mesopores is in the range of from 2 to 50 nm, which is greater than the diameter of sodium ion that is in the range of from 0.4 to 2 nm. The abundance ratio of mesopores is preferably higher than that of micropores, because mesopores can more absorb expansion of the graphite layers occurring in response to intercalation of sodium ion, which is advantageous for suppressing collapse of the crystal structure. The abundance ratio of micropores is reduced in a burning process for carbonizing the carbon particles (i.e., for growing crystals). Preferably, the volume of the micropores in the carbon particles ranges from 0.01 to 0.30 mL/g, more preferably from 0.01 to 0.10 mL/g.

The direction of opening of the pores in the anode active material is not limited. Preferably, the pores are randomly opened in various directions.

More specifically, the pores are randomly opened in various directions without any specific regulation or rule in relation to the direction of permeation of sodium ion into the anode active material. This is because if pores are formed with regularity in the anode active material, it will be difficult to occlude sodium ion from various angles.

The anode active material is not limited in shape but preferably in a spherical shape.

Whether the anode active material has crystallinity or not can be determined from an X-ray diffraction spectrum thereof. Preferably, the presence of crystallinity is confirmed when the X-ray diffraction spectrum has at least one diffraction peak within a Bragg angle 2θ range of from 25.00 to 27.00. More preferably, the presence of crystallinity is confirmed when the X-ray diffraction spectrum has two diffraction peak within this Bragg angle 2θ range.

An X-ray diffraction spectrum is obtainable by an X-ray diffractometer (XRD).

As X-rays enter a substance having a regular atomic arrangement, the X-rays are scattered by electrons that belong to the atoms, when the X-rays have a wavelength similar to the atomic spacing. The scattered X-rays interfere with each other to strengthen themselves in a specific direction, thus causing a diffraction of the X-rays.

Thus, the lattice spacing (i.e., the distance between lattices) of a crystal structure of a substance can be determined by measuring diffraction spectra with X-rays varied in wavelength.

As to an amorphous substance, since the lattice spacing has no regularity, the diffraction spectrum thereof has a gently-sloped-mountain-like or flat shape all over the wavelength range. On the other hand, as to a crystalline substance or part, since the lattice spacing has regularity, the diffraction spectrum thereof has a peak at a specific wavelength corresponding to the lattice spacing. Such a peak observed in a diffraction spectrum is hereinafter referred to as “diffraction peak”.

Having a diffraction peak within the above-described Bragg angle 2θ range indicates at least a partial crystallization of the carbon particles in the anode active material, in other words, a partial graphitization of the carbon particles.

The graphitized carbon particles are capable of being inserted with sodium ion and thereby providing a high capacity.

Having two diffraction peaks indicates the presence of two crystal structures having different lattice spacings. In this case, preferably, a ratio (Iₗ/Iₕ) of a diffraction peak intensity (Iₗ) of the lower-angle diffraction peak to a diffraction peak intensity (Iₕ)of the higher-angle diffraction peak is greater than 1, i.e., Iₗ/Iₕ>1 is satisfied.

As the ratio (Iₗ/Iₕ) becomes larger, the distance (d) between carbon layers in the graphitized region becomes larger. Accordingly, when the ratio (Iₗ/Iₕ) is greater than 1, a higher capacity is provided even when an anion is inserted without collapsing the carbon layer structure.

With respect to the definition of “crystallinity” of the anode active material, not all the carbon particles need to have a crystalline structure, and those having an amorphous structure may be present. Even in a case in which only a part of the carbon particles are crystallized, a diffraction peak emerges. However, in a case in which only a microcrystalline structure is present that exhibits amorphousness or no diffraction peak, such an anode active materials is not strong enough to endure insertion of sodium ion.

A Raman spectrum of a carbonaceous material is obtainable by laser Raman spectroscopy, more specifically, by irradiating the carbonaceous material with argon laser.

Generally, a Raman spectrum of the carbonaceous material has a peak P_{G} (abbreviated as “G band”) within a wavelength range of 1,580±100 cm⁻¹ that is a vibration mode originated from the crystal structure of graphite, and another peak P_{D} (abbreviated as “band”) within a wavelength range of 1,360±100 cm⁻¹ that is another vibration mode originated from the turbostratic structure of an amorphous part, i.e., a variation in binding state between carbon atoms.

As crystal growth of the carbonaceous material progresses, in the Raman Spectrum, an intensity (I_{G}) of the peak P_{G} increases while an intensity (I_{D}) of the peak P_{D} decreases. By contrast, as the structure of the carbonaceous material becomes more disordered, I_{G} decreases and I_{D} increases. Thus, the intensity ratio between the two peaks P_{G} and P_{D} can be treated as an indicator of the degree of graphitization and called as the graphitization degree (Rₕ).

In a case in which the anode active material exhibits a Raman spectrum having a peak P_{G} within a wavelength range of 1,580±100 cm⁻¹ and another peak P_{D} within a wavelength range of 1,360±100 cm⁻¹, when irradiated with laser light having a wavelength of 532 nm, as the graphitization degree Rₕ defined by the following formula (1) becomes larger, the degree of crystallinity becomes higher. By contrast, as the graphitization degree Rₕ becomes smaller, the degree of crystallinity becomes lower, i.e., the crystal structure of graphite becomes more disordered.

Graphitization Degree Rₕ=I_{D}/I_{G} Formula (1)

Accordingly, as the graphitization degree Rₕ becomes smaller, the number of graphite layers present in the carbonaceous material becomes larger, and a higher capacity is provided in response to insertion of sodium ion to between the graphite layers. Preferably, the graphitization degree Rₕ is in the range of from 0.25 to 0.80, and more preferably from 0.25 to 0.60. When Rₕ is in excess of 0.80, crystal growth of graphite becomes insufficient and therefore the number of sites where sodium ion is insertable reduces without providing a higher capacity. To accelerate crystal growth of graphite, a burning process is performed at a high temperature of 2,000° C. or above. However, since a large number of pores present inside carbon particles, heat is unevenly distributed and crystal growth is thereby suppressed. Thus, it is difficult to make the graphitization degree Rₕ be smaller than 0.25.

The structure of the anode active material having a plurality of pores forming a three-dimensional network structure is described in detail below.

As indicators of the condition of pores, specific surface area and pore distribution can be used. Both of them can be determined by the BET (Brunauer, Emmett, and Teller) method that measures a specific surface area from the adsorption amount of gaseous molecules, the adsorption occupancy area of which are known, to the surface of a sample, and measures a pore distribution by condensation of the gaseous molecules.

Preferably, the anode active material has a BET specific surface area in the range of from 50 to 1,500 m²/g, more preferably from 50 to 900 m²/g.

The BET specific surface area can be determined by the BET method using a measurement result (e.g., adsorption isotherm) obtained by an Automatic Surface Area and Porosimetry Analyzer (TriStar II 3020 available from Shimadzu Corporation).

A larger BET specific surface area indicates a larger amount of formation of pores.

When the BET specific surface area of the anode active material is within the above preferred range, the amount of formation of pores is sufficient. Thus, sodium ion can more easily migrate within the anode active material and can spread over the greater number of graphite layers, thereby increasing discharge capacity.

On the other hand, a material having too large a BET specific surface area, i.e., about 2,000 m²/g, such as activated carbon, reacts with the electrolytic solution so easily that decomposition of the electrolytic solution is accelerated through repeated charge and discharge, resulting in long-term deterioration of discharge capacity.

When the BET specific surface area of the anode active material is within the above preferred range, the anode active material is less reactive with the electrolytic solution, while the amount of formation of pores is sufficient. Thus, decomposition of the electrolytic solution is less likely to be accelerated and deterioration of discharge capacity through repeated charge and discharge is suppressed.

The carbonaceous material that becomes the anode active material may be prepared by heat-treating a starting material such as polyimide, phenolic resin, acrylic resin, and pitch-based thermosetting resin. The starting material is not limited to the above material, and other thermosetting resins may be used as the starting material.

Specific examples of such a carbonaceous material include, but are not limited to, CNovel® series (available from Toyo Tanso Co., Ltd.).

A method for producing the anode active material is described below.

First, a reinforcing material having a three-dimensional network structure and a starting material are shape-formed. The starting material is an organic matter serving as a carbon material forming source. The shape-formed materials are bunt at 2,000° C. or higher to be carbonized.

The reinforcing material is thereafter dissolved by an acid or a base, so that the trace of the reinforcing material becomes multiple mesopores formed in a three-dimensional network structure.

Specific preferred examples of the reinforcing material include, but are not limited to, acid-soluble or base-soluble metals. Specific examples of the reinforcing material further include, but are not limited to, metal oxides, metal salts, and metal-containing organic matters.

The starting material has no limit so long as it can be carbonized. The starting material is generally an organic matter. The organic matter releases volatile matters when carbonized while forming micropores as the traces of the released volatile matters. Accordingly, it is generally difficult to produce carbon particles with no micropore.

Generally, residual thermal stress remains in the burnt carbon material. It is known that thermal stress becomes larger when a mixture of different types of materials is burnt, due to the difference in coefficient of thermal expansion between the materials.

In the burning process in the above-described method for producing the anode active material, the peripheral and central portions of the wall part of the pore, that is formed as the reinforcing material is dissolved, are applied with heat and pressure in different ways. Therefore, residual thermal stresses remaining in the peripheral and central portions also differ from each other.

Such a difference in thermal stress is likely to cause a difference in lattice spacing of carbon particles. In addition, due to the burning process, it is likely that the structure of the carbonaceous material is partially changed to a crystal structure. Accordingly, the crystal structure of the anode active material exhibits two diffraction peaks in a Bragg angle 2θ range of from 25.00 to 27.00.

### Conductive Auxiliary Agent

Specific examples of the conductive auxiliary agent include, but are not limited to, metallic materials and carbonaceous materials.

Specific examples of the metallic materials include, but are not limited to, copper and aluminum.

Specific examples of the carbonaceous materials include, but are not limited to, acetylene black, Ketjen black, synthetic graphite, natural graphite, graphene, carbon nanofiber, and carbon nanotube. Each of these materials can be used alone or in combination with others. Among these materials, acetylene black and Ketien black are preferable.

### Binder and Thickener

The binder and thickener are not limited so long as they are stable against the types of solvent and electrolytic solution used in preparing the electrode and the applied potential. Specific examples of the binder and thickener include, but are not limited to, fluorine-based binder, ethylene-propylene-butadiene rubber (EPBR), styrene-butadiene rubber (SBR), isoprene rubber, acrylate-based latex, carboxymethyl cellulose (CMC), methyl cellulose, hydroxymethyl cellulose, ethyl cellulose, polyacrylic acid, polyvinyl alcohol, alginic acid, oxidized starch, starch phosphate, and casein.

Specific examples of the fluorine-based binder include, but are not limited to, polyvinylidene fluoride (PVDF) and polytetrafluoroethylene (PTFE).

Each of these materials can be used alone or in combination with others.

Among these materials, SBR, fluorine-based binder, acrylate-based latex, and carboxymethyl cellulose (CMC) are preferable.

### Anode Collector

The anode collector is not limited in shape.

The anode collector is not limited in size so long as it has an appropriate size for use in the nonaqueous electrolytic solution storage element.

The anode collector is not limited in material so long as it is formed of a conductive material that is stable against the applied potential. Specific examples of such materials include, but are not limited to, stainless steel, nickel, aluminum, and copper. In particular, stainless steel, copper, and aluminum are preferable.

### Method for Preparing Anode

The anode may be prepared by: mixing the anode active material with the binder, the thickener, the conductive auxiliary agent, and/or a solvent to prepare a slurry anode material; applying the slurry anode material onto the anode collector and drying the applied anode material.

Examples of the solvent include, but are not limited to, aqueous solvents and organic solvents.

Specific examples of the aqueous solvents include, but are not limited to, water and alcohols.

Specific examples of the organic solvents include, but are not limited to, N-methyl-2-pyrrolidone (NMP) and toluene.

Alternatively, the anode active material may be directly formed into a sheet-like electrode or a pellet-like electrode by roll forming or compression molding, respectively.

### Cathode

The cathode has no limit so long as a cathode active material is contained therein. For example, the cathode may comprise a cathode collector and a cathode material, containing the cathode active material, disposed on the cathode collector.

The cathode is not limited in shape and may be in a plate-like or sheet-like shape.

### Cathode Material

The cathode material contains the cathode active material. The cathode material may further contain a conductive auxiliary agent, a binder, and/or a thickener.

### Cathode Active Material

The cathode active material has no limit so long as it is capable of occluding and releasing a cation in nonaqueous solvents. Specific examples of the cathode active material include, but are not limited to, sodium-containing transition metal oxides capable of occluding and releasing sodium ion (as a cation), transition metal fluorides, polyanion and fluorinated polyanion materials, and transition metal sulfides.

Specific examples of the sodium-containing transition metal oxides include, but are not limited to, NaₓMe¹_{y}O₂(where 0<x≦1 and 0.95≦y<1.05 are satisfied and Me¹ includes at least one of Fe, Mn, Ni, Co, Cr, and Ti).

Specific examples of the transition metal fluorides include, but are not limited to, NaFeF₃, NaMnF₃, and NaNiF₃.

Specific examples of the polyanion and fluorinated polyanion materials include, but are not limited to, NaMe²PO₄, Na₃Me²₂(PO₄)₃, Na₄Me²₃(PO₄)₂P₂O₇, Na₂Me²PO₄F, and Na₃Me²₂(PO₄)₂F₃(where Me²includes at least one of Fe, Mn, Ni, Co, Ti, V, and Mo).

Specific examples of the transition metal sulfides include, but are not limited to, Ni₃S₂, F₂S₂, and TiS₂.

Specific examples of the cathode active material further include carbonaceous materials capable of occluding and releasing an anion within a voltage range of from 3 to 6 V relative to the sodium potential.

Specific examples of such carbonaceous materials include, but are not limited to, graphites and pyrolysis products of organic matters produced under various pyrolysis conditions.

Specific examples of the graphites include, but are not limited to, coke, synthetic graphite, natural graphite, easily-graphitizable carbon, and poorly-graphitizable carbon. Each of these materials can be used alone or in combination with others. In particular, synthetic graphite and natural graphite are preferable because they are safe and cost-friendly and have a plateau at a high voltage for anion intercalation.

### Conductive Auxiliary Agent

Specific examples of the conductive auxiliary agent include those exemplified for use in the anode active material.

### Binder and Thickener

Specific examples of the binder and thickener include those exemplified for use in the anode active material.

Among these materials, fluorine-based binder, acrylate-based latex, and carboxymethyl cellulose (CMC) are preferable.

### Cathode Collector

The cathode collector is not limited in shape.

The cathode collector is not limited in size so long as it has an appropriate size for use in the nonaqueous electrolytic solution storage element.

The cathode collector is not limited in material so long as it is formed of a conductive material that is stable against the applied potential. Specific examples of such materials include, but are not limited to, stainless steel, nickel, aluminium titanium, and tantalum. In particular, stainless steel and aluminum are preferable.

### Method for Preparing Cathode

The cathode may be prepared by: mixing the cathode active material with the binder, the thickener, the conductive auxiliary agent, and/or a solvent to prepare a slurry cathode material; applying the slurry cathode material onto the cathode collector; and drying the applied cathode material. Alternatively, the slurry cathode material may be directly formed into a sheet-like electrode or a pellet-like electrode by roll forming or compression molding, respectively. Furthermore, the cathode may be prepared by forming a thin film of the cathode active material on the cathode collector by vapor deposition, sputtering, or plating,

Specific examples of the solvent include those exemplified for use in the method for preparing the anode.

### Nonaqueous Electrolytic Solution

The nonaqueous electrolytic solution contains a nonaqueous solvent and an electrolyte salt.

### Nonaqueous Solvent

Specific examples of the nonaqueous solvent include, but are not limited to, aprotic organic solvents, ester-based organic solvents, and ether-based organic solvents. Each of these materials can be used alone or in combination with others. In particular, aprotic organic solvents are preferable.

Specific examples of the aprotic organic solvents include, but are not limited to, carbonate-based organic solvents. In particular, those having a low viscosity are preferable,

Specific examples of the carbonate-based organic solvents include, but are not limited to, chain-like carbonates and cyclic carbonates.

In particular, chain-like carbonates are preferable for their high electrolyte-salt-dissolving power.

Specific examples of the chain-like carbonates include, but are not limited to, dimethyl carbonate (DMC), diethyl carbonate (DEC), and methyl ethyl carbonate: (EMC). Each of these materials can be used alone or in combination with others. Among these materials, dimethyl carbonate (DMC) and methyl ethyl carbonate (EMC) are preferable.

Dimethyl carbonate (DMC) and methyl ethyl carbonate (EMC) may be combined at an arbitrary ratio as a mixed solvent.

Specific examples of the cyclic carbonates include, but are not limited to, propylene carbonate (PC), ethylene carbonate (EC), butylene carbonate (BC), vinylene carbonate (VC), and fluoroethylene carbonate (FEC). Each of these materials can be used alone or in combination with other. Among these materials, propylene carbonate (PC) and ethylene carbonate (EC) are preferable.

Ethylene carbonate (EC) as a cyclic carbonate and dimethyl carbonate (DMC) as a chain-like carbonate may be combined at an arbitrary ratio as a mixed solvent.

Specific examples of the ester-based organic solvents include, but are not limited to, cyclic esters and chain-like esters.

Specific examples of the cyclic esters include, but are not limited to, γ-butyrolactone (γ-BL), 2-methyl-γ-butyrolactone, acetyl-γ-butyrolactone, and γ-valerolactone.

Specific examples of the chain-like esters include, but are not limited to, propionic acid alkyl esters, malonic acid dialkyl esters, acetic acid alkyl esters, and formic acid alkyl esters.

Specific examples of the acetic acid alkyl esters include, but are not limited to, methyl acetate (MA) and ethyl acetate.

Specific examples of the formic acid alkyl esters include, but are not limited to, methyl formate (MF) and ethyl formate.

Specific examples of the ether-based organic solvents include, hut are not limited to, cyclic ethers and chain-like ethers.

Specific examples of the cyclic ethers include, but are not limited to, tetrahydrofuran, alkyltetrahydrofuran, alkoxytetrahydrofuran, dialkoxytetrahydrofuran, 1,3-dioxolan, alkyl-1,3-dioxolan, and 1,4-dioxolan.

Specific examples of the chain-like ethers include, but are not limited to, 1,2-dimethoxyethane (DME), diethyl ether, ethylene glycol dialkyl ether, diethylene glycol dialkyl ether, triethylene glycol dialkyl ether, and tetraethylene glycol dialkyl ether.

### Electrolyte Salt

Preferably, the electrolyte salt is a sodium salt. The sodium salt has no limit so long as it is soluble in nonaqueous solvents and has a high ion conductivity. Specific examples of such a sodium salt include, but are not limited to, sodium hexafluorophosphate (NaPF₆), sodium perchlorate (NaClO₄), sodium chloride (NaCl), sodium fluoroborate (NaBF₄), sodium hexafluoroarsenate (NaAsF₆), sodium trifluromethanesulfonate (NaCF₃SO₃), sodium bis(fluorosulfonyl)imide (NaN(SO₂F)₂), sodium bis(trifluoromethylsulfonyl)imide (NaN(SO₂CF₃)₂), and sodium bis(perfluoroethylsulfonyl)imide (NaN(SO₂C₂F₅)₂). Each of these materials can he used alone or in combination with others. Among these materials, sodium hexafluorophosphate (NaPF₆) and sodium fluoroborate (NaBF₄) are preferable for their cyclic property and capacity.

Preferably, the content of the electrolyte salt in the nonaqueous solvent is in the range of from 0.5 to 6 mol/L, more preferably from 1 to 4 mol/L, for achieving both discharge capacity and power.

### Other Members

The nonaqueous electrolytic solution storage element may further include optional members such as a separator.

### Separator

The separator may be disposed between the cathode and the anode for preventing short circuit therebetween.

The separator is not limited in material, shape, size, and structure.

The separator may be made of, for example, paper (e.g., craft paper, vinylon mixed paper, synthetic pulp mixed paper), cellophane, polyethylene grafted film, polyolefin unwoven fabric (e.g., polypropylene melt-blown unwoven fabric) polyamide unwoven fabric, glass fiber unwoven fabric, and micropore film. In particular, those having a porosity of 50% or more are preferable for retaining the electrolytic solution.

Preferably, the separator is in an unwoven-fabric-like shape having a high porosity rather than a thin-film-like shape having micropores.

Preferably, the average thickness of the separator ranges from 20 to 100 μm for preventing short circuit and retaining the electrolytic solution.

The separator is not limited in size so long as it has an appropriate size for use in the nonaqueous electrolytic solution storage element.

The separator may have either a monolayer structure or a laminate structure.

### Method for Manufacturing Nonaqueous Electrolytic Solution Storage Element

The nonaqueous electrolytic solution storage element according to an embodiment of the present invention may be manufactured by assembling the cathode, the anode, the nonaqueous electrolytic solution, and the optional separator into an appropriate shape. Other structural members, such as an outer can, may also be assembled with the above members.

The nonaqueous electrolytic solution storage element is not limited in shape. The shape is determined according to the use application. For example, the nonaqueous electrolytic solution storage element may be in a cylinder-like shape in which a sheet-like electrode and a separator are assembled in a spiral manner, another cylinder-like shape in which a pellet-like electrode and a separator are combined into an inside-out structure, or a coin-like shape in which a pellet-like electrode and a separator are laminated.

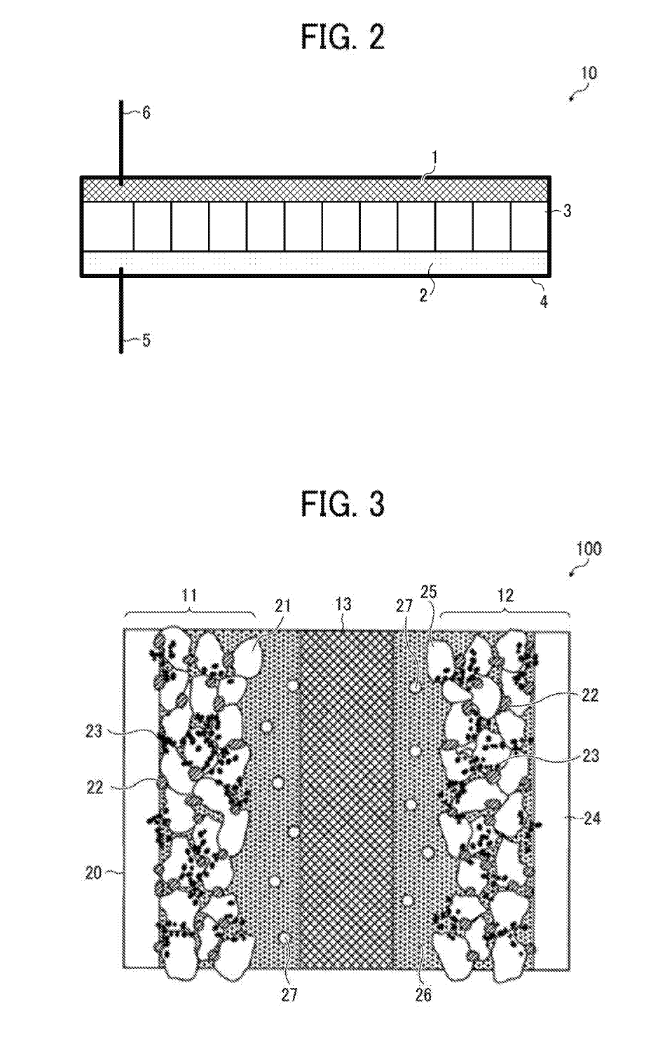

FIG. 2 is a schematic view of a nonaqueous electrolytic solution storage element 10 according to an embodiment of the present invention. Referring to FIG. 2, the nonaqueous electrolytic solution storage element 10 includes a cathode 1 an anode 2, a separator 3 retaining a nonaqueous electrolytic solution, an outer can 4, a cathode lead wire 6, and an anode lead wire 5. The nonaqueous electrolytic solution storage element 10 may optionally include other members, if necessary.

Specific examples of the nonaqueous electrolytic solution storage element 10 include, but are not limited to, a nonaqueous electrolytic solution secondary battery and a nonaqueous electrolytic solution capacitor.

FIG. 3 is a schematic view of a nonaqueous electrolytic solution storage element 100 according to another embodiment of the present invention.

The nonaqueous electrolytic solution storage element 100 includes a cathode 11 and an anode 12. The cathode 11 includes a cathode collector 20 made of aluminum, a cathode active material 21 fixed on the cathode collector 20, a binder 22 that binds particles of the cathode active material 21, and a conductive auxiliary agent 23 that gives conductive paths between particles of the cathode active material 21.

The anode 12 includes an anode collector 24 made of copper, a carbonaceous material 25 serving as an anode active material fixed on the anode collector 24, the binder 22 that binds particles of the carbonaceous material 25, and the conductive auxiliary agent 23 that gives conductive paths between particles of the carbonaceous material 25.

A separator 13 and a nonaqueous electrolytic solution 26 are disposed between the cathode 11 and the anode 12. A reference numeral 27 denotes ions. As the ions 27 are inserted to or separated from between active material layers, charge or discharge occurs.

### Use Application

The nonaqueous electrolytic solution storage element according to an embodiment of the present invention may be applied to, for example, power sources and backup power sources for laptop computers, pen input personal computers, mobile personal computers, electronic book players, cellular phones, portable facsimile machines, portable copiers, portable printers, headphone stereos, video movie recorders, liquid crystal display televisions, handy cleaners, portable CD players, mini disk players, transceivers, electronic organizers, calculators, memory cards, portable tape recorders, radios, motors, illumination apparatuses, toys, game machines, clocks, electronic flashes, and cameras.

### EXAMPLES

Further understanding can be obtained by reference to certain specific examples which are provided herein for the purpose of illustration only and are not intended to be limiting. In the following examples, sodium-ion secondary batteries are provided as the nonaqueous electrolytic solution storage elements according to some embodiments of the present invention.

First, carbonaceous materials used in the following examples and comparative examples were subjected to the following evaluations to determine their pore formation condition and crystallinity.

### Pore Formation Condition of Anode Active Material

Each anode active material was observed with a TEM (transmission electron microscope JEM-2100 available from JEOL Ltd.) to determine whether pores forming a three-dimensional network structure were present or not. The pore formation condition was evaluated based on the following criteria.

Evaluation Criteria
Yes: Pores forming a three-dimensional network structure as illustrated in FIG. 1 were observed.
No: Pores forming a three-dimensional network structure as illustrated in FIG. 1 were not observed.

### Crystallinity of Anode Active Material

An X-ray diffraction spectrum of each anode active material was obtained with an X-ray diffractometer (D8 DISCOVER available from Bruker) by an X-ray diffractometry. As the X-ray source, CuKα ray was used.

Crystallinity of each anode active material was evaluated by the number and angles of peaks present within a Bragg angle 2θ range of from 25.00 to 27.00 in its X-ray diffraction spectrum, that were originated from regularity of the layer structure of graphite. In a case in which two peaks were present, a ratio (Iₗ/Iₕ) of an intensity Iₗ of the lower-angle diffraction peak to an intensity Iₕ of the higher-angle diffraction peak was used to evaluate crystallinity.

Evaluation Criteria
Yes: Having crystallinity
No: No crystallinity

### Measurement of BET Specific Surface Area and Pore Volume of Anode Active Material

The BET specific surface area of each anode active material was determined by the BET method using a measurement result (e.g., adsorption isotherm) obtained by an Automatic Surface Area and Porosimetry Analyzer (TriStar II 3020 available from Shimadzu Corporation).

The volume of micropores in the anode active material particles was determined by the (Horbath-Kawazoe) method using the measurement result (e.g., adsorption isotherm) used in the measurement of BET specific surface area.

### Graphitization Degree of Anode Active Material

A Raman spectrum of each anode active material was obtained with a laser Raman spectrometer (Nanofinder® 30 available from Tokyo Instruments, Inc.) by a laser Raman spectroscopy. As the laser, argon layer was used.

The graphitization degree (Rₕ) of each anode active material was evaluated by a ratio (I_{D}/I_{G}) of an intensity (I_{D}) of a peak P_{D} observed at a wavelength range of 1,360 ±100 cm⁻¹ to an intensity (I_{G}) of the peak P_{G} observed at a wavelength range of 1,580±100 cm⁻¹ in the Raman spectrum.

### Example 1

### Preparation of Anode

### Preparation of Anode Slurry

A porous carbon having crystallinity and a plurality of pores forming a three-dimensional network structure (CNovel® available from Toyo Tanso Co., Ltd., hereinafter referred to as “carbon A”) serving as the anode active material, an acetylene black (DENKA BLACK available from Denka Company Limited) serving as the conductive auxiliary agent, a styrene-butadiene rubber (EX1215 available from Denka Company Limited) serving as the binder, and a carboxymethyl cellulose (CMC DAICEL 2200 available from Daicel FineChem Ltd.) serving as the thickener, with the mass ratio thereof being 100/5.0/3.0/2.0 based on solid contents, were mixed with a planetary mixer (HIVIS DISPER MIX Model 3D-2 available from PRIMIX Corporation). The resulting mixture was further mixed with water to have an appropriate viscosity. Thus, an anode slurry was prepared.

### Preparation of Anode

The above-prepared anode shiny was applied onto one surface of a copper foil having an average thickness of 18 μm, serving as the anode collector, with a doctor blade. The average mass of the carbon active material in the applied anode slurry after being dried was adjusted to 0.8 mg/cm². The foil having the dried anode slurry thereon was punched into a circle having a diameter of 16 mm as an anode.

### Separator

Two pieces of a glass filter (ADVANTEC® GA-100 available from Toyo Roshi Kaisha, Ltd.) punched into a circle having a diameter of 16 mm were prepared as the separator.

### Cathode

A sodium metal foil punched into a circle having a diameter of 16 mm was used as a cathode.

### Nonaqueous Electrolytic Solution

A solution of 1 mol/L of an electrolyte NaPF₆ in a mixture of ethylene carbonate (EC) and dimethyl carbonate (DMC) with a mass ratio being 1/1 (available from Kishida Chemical Co., Ltd.) was used as the nonaqueous electrolytic solution.

### Preparation of Sodium-Ion Secondary Battery

The above-prepared anode, cathode, and separator and a coil cell member were vacuum-dried at 150° C. for 4 hours and thereafter assembled into a CR2032-type coin cell, as the nonaqueous electrolytic solution storage element, in a glove box filled with dry argon atmosphere.

Further, 400 μL of the nonaqueous electrolytic solution was injected into the CR2032-type coin cell.

The sodium-ion secondary battery obtained in Example 1 was subjected to the following charge-discharge test.

### Charge-Discharge Test

The sodium-ton secondary battery obtained in Example 1. was held in a thermostatic chamber having a temperature of 23° C. and subjected to a charge-discharge test using an automatic battery evaluation device (1024B-7V 0.1A-4 available from Electro Field Co., Ltd.) as described below.

The first charge and discharge were performed as a pretreatment (aging treatment) for the purpose of evenly impregnating the electrolytic solution into the electrode. Specifically, in the pretreatment (aging treatment), the battery was left to stand for 24 hours, charged to a charge final voltage of 0.01 V by constant-current charge, left to stand for 24 hours, and charged to a discharge final voltage of 1.50 V by constant-current discharge. After the aging treatment, the charge-discharge test was performed in the following manner.

During the charge and discharge, the current value was so adjusted that the current density became 0.3 A/g based on the weight of the anode active material.

[1]: Constant-current charge to 0.01 V with a current value having a current density of 0.3 A/g

[2]: Stop for 5 minutes

[3]: Constant-current charge to 1.50 V with a current value having a current density of 0.3 A/g

[4]: Stop for 5 minutes

After the charge-discharge test, discharge capacity (mAh/g) per 1 g of the anode active material was measured.

High capacitance property of the anode active material was evaluated based on the following criteria. Here, high capacitance property refers to a property of maintaining a high capacity (i e., high-capacitance long-lifespan property). The results are presented in Table 1-1.

### Evaluation Criteria

Good: Discharge capacity was greater than 372 mAh/g.

Poor: Discharge capacity was 372 mAh/g or less.

### Examples 2 to 10

In Examples 2 to 10, the procedure in Example 1 was repeated except for replacing the anode active material (carbon A) with respective anode active materials (carbons B to J, CNovel® series available from Toyo Tanso Co., Ltd.) having different crystal property, BET specific surface area, and graphitization degree, as described in Tables 1-1 and 1-2. Thus, sodium-ion secondary batteries of Examples 2 to 10 were prepared and evaluated in the same manner as in Example 1. The results are presented in Tables 1-1 and 1-2.

### Comparative Example 1

The procedure in Example 1 was repeated except for replacing the anode active material (carbon A) with another anode active material (natural graphite Special CP available from Nippon Graphite Industries, Co., Ltd.). Thus, a sodium-ion secondary battery of Comparative Example 1 was prepared and evaluated in the same manner as in Example 1 The results are presented in Table 1-3.

### Comparative Example 2

The procedure in Example 1 was repeated except for replacing the anode active material (carbon A) with another anode active material (poorly-graphitizable carbon BELLFINE® LN available from AT ELECTRODE CO., LTD.). Thus, a sodium-ion secondary battery of Comparative Example 2 was prepared and evaluated in the same manner as in Example 1. The results are presented in Table 1-3.

### Comparative Example 3

The procedure in Example 1 was repeated except for replacing the anode active material (carbon A) with another anode active material (carbon K, a porous carbon CNovel® available from Toyo Tanso Co., Ltd.) having different crystal property, BET specific surface area, and graphitization degree, as described in Table 1-3. Thus, a sodium-ion secondary battery of Comparative Example 3 was prepared and evaluated in the same manner as in Example 1. The results are presented in Table 1-3.

TABLE 1-1

| | | | | Example | Example | Example | Example | Example |
|---|---|---|---|---|---|---|---|---|
| | | | | 1 | 2 | 3 | 4 | 5 |
| Anode | Anode | Anode | Carbon Type | Carbon A | Carbon B | Carbon C | Carbon D | Carbon E |
| | Material | Active | Three-dimensional | Yes | Yes | Yes | Yes | Yes |
| | | Material | Network Structure | | | | | |
| | | | Crystallinity | Yes | Yes | Yes | Yes | Yes |
| | | | Number of Peaks | 2 | 2 | 2 | 2 | 2 |
| | | | Bragg Angle 2θ (°) | 26.1 | 26.1 | 26.1 | 26.1 | 26.1 |
| | | | | 26.6 | 26.5 | 26.6 | 26.6 | 26.6 |
| | | | Intensity Ratio (Iₜ/Iₕ) | 3.8 | 1.2 | 1.3 | 1.2 | 1.2 |
| | | | Specific Surface | 200 | 90 | 310 | 464 | 501 |
| | | | Area (m²/g) | | | | | |
| | | | Volume of | 0.07 | 0.03 | 0.11 | 0.16 | 0.18 |
| | | | Micropores (mL/g) | | | | | |
| | | | Graphitization Degree | 0.25 | 0.55 | 0.60 | 0.66 | 0.70 |
| | | | Rₕ (I_{D}/I_{G}) | | | | | |
| | | Amount of Active Material per | | 0.8 | 0.8 | 0.8 | 0.8 | 0.8 |
| | | Unit Area (mg/cm²) | | | | | | |
| | | Binder | | Styrene- | Styrene- | Styrene- | Styrene- | Styrene- |
| | | | | Butadiene | Butadiene | Butadiene | Butadiene | Butadiene |
| | | | | Rubber | Rubber | Rubber | Rubber | Rubber |
| | | Conductive Auxiliary Agent | | Acetylene | Acetylene | Acetylene | Acetylene | Acetylene |
| | | | | Black | Black | Black | Black | Black |
| | | Thickener | | Carboxy- | Carboxy- | Carboxy- | Carboxy- | Carboxy- |
| | | | | methyl | methyl | methyl | methyl | methyl |
| | | | | Cellulose | Cellulose | Cellulose | Cellulose | Cellulose |
| | Anode Collector | | Material | Copper | Copper | Copper | Copper | Copper |
| | | | | Foil | Foil | Foil | Foil | Foil |
| | | | Average Thickness | 18 | 18 | 18 | 18 | 18 |
| | | | (μm) | | | | | |
| Cathode | | | | Sodium | Sodium | Sodium | Sodium | Sodium |
| | | | | Metal | Metal | Metal | Metal | Metal |
| | | | | Foil | Foil | Foil | Foil | Foil |
| Charge-Discharge Test | | | Voltage Range (V) | 0.01-1.50 | 0.01-1.50 | 0.01-1.50 | 0.01-1.50 | 0.01-1.50 |
| Conditions | | | Current Density (A/g) | 0.3 | 0.3 | 0.3 | 0.3 | 0.3 |
| Evaluation Results | | | Discharge Capacity | 923 | 798 | 571 | 551 | 522 |
| | | | (mAh/g ) | | | | | |
| | | | High Capacitance | Good | Good | Good | Good | Good |
| | | | Property | | | | | |

TABLE 1-2

| | | | | Example | Example | Example | Example | Example |
|---|---|---|---|---|---|---|---|---|
| | | | | 6 | 7 | 8 | 9 | 10 |
| Anode | Anode | Anode | Carbon Type | Carbon F | Carbon G | Carbon H | Carbon I | Carbon J |
| | Material | Active | Three-dimensional | Yes | Yes | Yes | Yes | Yes |
| | | Material | Network Structure | | | | | |
| | | | Crystallinity | Yes | Yes | Yes | Yes | Yes |
| | | | Number of Peaks | 2 | 2 | 2 | 2 | 1 |
| | | | Bragg Angle 2θ (°) | 26.1 | 26.1 | 26.1 | 26.1 | 26.5 |
| | | | | 26.6 | 26.6 | 26.6 | 26.6 | |
| | | | Intensity Ratio (Iₜ/Iₕ) | 1.1 | 1.6 | 1.6 | 0.9 | — |
| | | | Specific Surface | 540 | 860 | 910 | 320 | 960 |
| | | | Area (m²/g) | | | | | |
| | | | Volume of | 0.20 | 0.29 | 0.30 | 0.11 | 0.31 |
| | | | Micropores (mL/g) | | | | | |
| | | | Graphitization Degree | 0.74 | 0.77 | 0.81 | 0.64 | 0.82 |
| | | | Rₕ (I_{D}/I_{G}) | | | | | |
| | | Amount of Active Material | | 0.8 | 0.8 | 0.8 | 0.8 | 0.8 |
| | | per Unit Area (mg/cm²) | | | | | | |
| | | Binder | | Styrene- | Styrene- | Styrene- | Styrene- | Styrene- |
| | | | | Butadiene | Butadiene | Butadiene | Butadiene | Butadiene |
| | | | | Rubber | Rubber | Rubber | Rubber | Rubber |
| | | Conductive Auxiliary Agent | | Acetylene | Acetylene | Acetylene | Acetylene | Acetylene |
| | | | | Black | Black | Black | Black | Black |
| | | Thickener | | Carboxy- | Carboxy- | Carboxy- | Carboxy- | Carboxy- |
| | | | | methyl | methyl | methyl | methyl | methyl |
| | | | | Cellulose | Cellulose | Cellulose | Cellulose | Cellulose |
| | Anode Collector | | Material | Copper | Copper | Copper | Copper | Copper |
| | | | | Foil | Foil | Foil | Foil | Foil |
| | | | Average Thickness | 18 | 18 | 18 | 18 | 18 |
| | | | (μm) | | | | | |
| Cathode | | | | Sodium | Sodium | Sodium | Sodium | Sodium |
| | | | | Metal | Metal | Metal | Metal | Metal |
| | | | | Foil | Foil | Foil | Foil | Foil |
| Charge-Discharge Test | | | Voltage Range (V) | 0.01-1.50 | 001-1.50 | 0.01-1.50 | 0.01-1.50 | 0.01-1.50 |
| Conditions | | | Current Density (A/g) | 0.3 | 0.3 | 0.3 | 0.3 | 0.3 |
| Evaluation Results | | | Discharge Capacity | 513 | 501 | 485 | 411 | 392 |
| | | | (mAh/g) | | | | | |
| | | | High Capacitance | Good | Good | Good | Good | Good |
| | | | Property | | | | | |

TABLE 1-3

| | | | | Comparative | Comparative | Comparative |
|---|---|---|---|---|---|---|
| | | | | Example 1 | Example 2 | Example 3 |
| Anode | Anode | Anode | Carbon Type | Natural | Poorly- | Carbon K |
| | Material | Active | | Graphite | graphitizable | |
| | | Material | | | Carbon | |
| | | | Three-dimensiorsal | No | No | Yes |
| | | | Network Structure | | | |
| | | | Crystallinity | Yes | Yes | No |
| | | | Number of Peaks | 1 | 1 | 0 |
| | | | Bragg Angle 2θ (°) | 26.5 | 24.5 | — |
| | | | Intensity Ratio (Iₜ/Iₕ) | — | — | — |
| | | | Specific Surface | 10 | 8 | 1580 |
| | | | Area (m²/g) | | | |
| | | | Volume of | — | — | 0.57 |
| | | | Micropores (mL/g) | | | |
| | | | Graphitization Degree | 0.05 | 1.00 | 1.05 |
| | | | Rₕ (I_{D}/I_{G}) | | | |
| | | Amount of Active Material per | | 0.8 | 0.8 | 0.8 |
| | | Unit Area (mg/cm²) | | | | |
| | | Binder | | Styrene- | Styrene- | Styrene- |
| | | | | Butadiene | Butadiene | Butadiene |
| | | | | Rubber | Rubber | Rubber |
| | | Conductive Auxiliary Agent | | Acetylene | Acetylene | Acetylene |
| | | | | Black | Black | Black |
| | | Thickener | | Carboxy- | Carboxy- | Carboxy- |
| | | | | methyl | methyl | methyl |
| | | | | Cellulose | Cellulose | Cellulose |
| | | | Material | Copper Foil | Copper Foil | Copper Foil |
| | Anode Collector | | Average Thickness | 18 | 18 | 18 |
| | | | (μm) | | | |
| Cathode | | | | Sodium | Sodium | Sodium |
| | | | | Metal Foil | Metal Foil | Metal Foil |
| Charge-Discharge Test | | | Voltage Range (V) | 0.01-1.50 | 0.01-1.50 | 0.01-1.50 |
| Conditions | | | Current Density (A/g) | 0.3 | 0.3 | 0.3 |
| Evaluation Results | | | Discharge Capacity | 16 | 337 | 145 |
| | | | (mAh/g) | | | |
| | | | High Capacitance | Poor | Poor | Poor |
| | | | Property | | | |

It is clear from Tables 1-1 to 1-3 that, among the carbons A to K that are porous carbons having a plurality of pores forming a three-dimensional network structure inside, only the carbons A to J have crystallinity according to their X-ray diffraction spectrum.

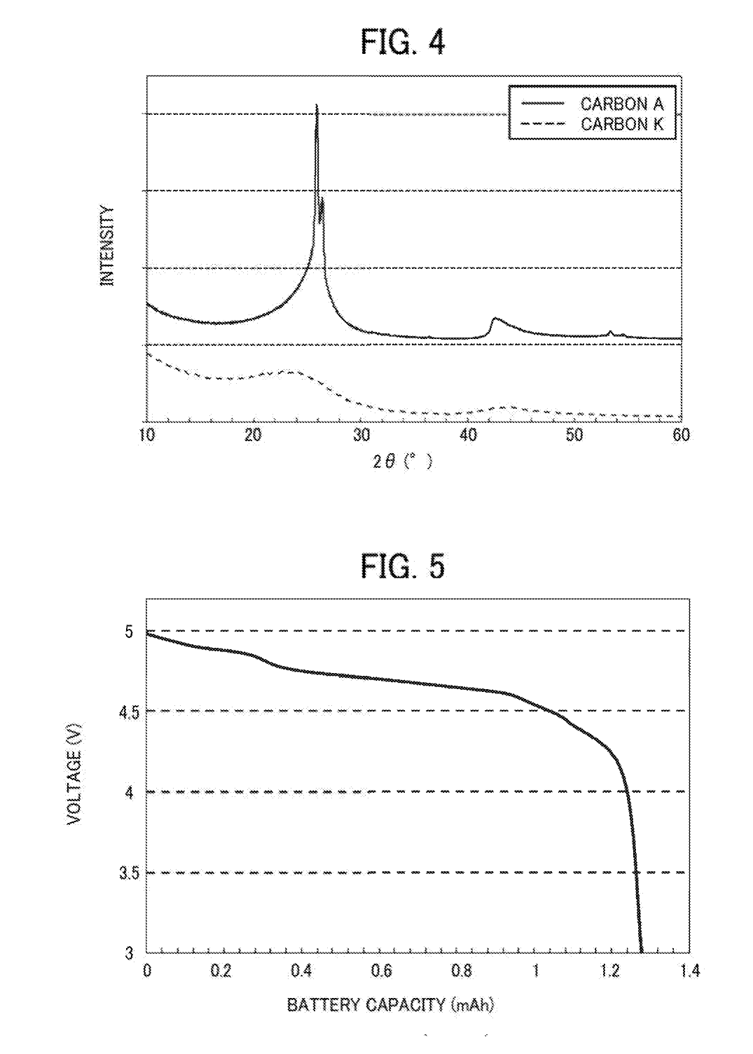

FIG. 4 is a graph showing X-ray diffraction spectra or the carbons A and K. Referring to FIG. 4, the carbon A has a diffraction peak within a Bragg angle 2θ range of from 25.00 to 27.00. Having a diffraction peak within that Bragg angle 2θ range means that a crystal structure originated from the graphite layer structure is grown in the carbon particles of the anode active material. Accordingly, in Examples 1 to 10, in each of which a porous carbon having crystallinity and a plurality of pores forming a three-dimensional network structure inside is used as the anode active material, discharge capacity is higher than that in each of Comparative Examples 1 to 3.

In addition, in the carbons A to J, the graphite layers are regularly arranged by the burning process, thus growing a crystal structure. As crystal grows, the abundance ratio of micropores is reduced. Thus, discharge capacity is larger in Examples 1 to 10 in which the carbons A to J having a relatively small volume of micropores are used as the anode active material than in Comparative Example 3 in which the carbon K is used as the anode active material. Comparison between Example 10 and Examples 1-9 indicates that the volume of micropores in the porous carbon as the anode active material is preferably in the range of from 0.01 to 0.30 mL/g.

Next, crystallinity of each anode active material is discussed below referring to Tables 1-1 to 1-3 based on the number of diffraction peaks present in the Bragg angle 2θ range of from 25.00 to 27.00 in each X-ray diffraction spectrum.

Comparison between Example 10 and Comparative Example 3 indicates that, in Example 10 in which only one diffraction peak is present within the Bragg angle 2θ range of from 25.00 to 27.00, i.e., at a Bragg angle 2θ of 26.5, the volume of micropores is small and discharge capacity is higher than that in Comparative Example 3.

As described above, having a diffraction peak within the Bragg angle 2θ range of from 25.00 to 27.00 indicates that at least a part of the carbon particles of the anode active material are crystallized. Thus, an anode active material having such a diffraction peak is much easier to insert sodium ion and the capacity thereof becomes much higher.

Comparison between Example 10 and Examples 1-9 indicates that the number of diffraction peaks present within the Bragg angle 2θ range of from 25.00 to 27.00 is preferably two, for improving discharge capacity.

Comparison between Example 9 and Examples 1-8 indicates that the intensity ratio (Iₗ/Iₕ) between two diffraction peaks is preferably larger than 1, for improving discharge capacity.

Next, the graphitization degree Rₕ=I_{D}/I_{G} of the anode active material is discussed below referring to Tables 1-1 and 1-2.

Comparison between Examples 1 to 8 indicates that as the graphitization degree Rₕ becomes smaller discharge capacity becomes higher. Because the graphitization degree Rₕ indicates the degree of disorder in crystallinity of a carbonaceous material, as the graphitization degree Rₕ becomes smaller, the number of graphite layers present in the carbonaceous material becomes larger. Accordingly, as the graphitization degree Rₕ becomes smaller, sodium ion is more frequently insertable into graphite layers and the capacity becomes higher. Comparison between Example 8 and Examples 1-7 indicates that the graphitization degree Rₕ is preferably in the range of from 0.25 to 0.80.

Thus, the sodium-ion secondary batteries of Examples 1 to 10 have a much higher discharge capacity.

### Example 11

The procedure in Example 2 was repeated except for replacing the cathode with another cathode prepared below. Thus, a sodium-ion secondary battery of Example 11 was prepared and evaluated in the same manner as in Example 2.

### Preparation of Cathode

### Preparation of Cathode Slurry

A synthetic graphite (KS-6 available from TIMKAL) serving as the cathode active material, an acetylene black (DENKA BLACK available from Denka Company Limited) serving as the conductive auxiliary agent, an acrylate-based latex (TRD202A available from JSR Corporation) serving as the binder, and a carboxymethyl cellulose (CMC DAICEL 2200 available from Daicel FineChem Ltd.) serving as the thickener, with the mass ratio thereof being 100/7.5/3.0/3.8 based on solid contents, were mixed. The resulting mixture was further mixed with water to have an appropriate viscosity. Thus, a cathode slurry was prepared.

### Preparation of Cathode

The above-prepared cathode slurry was applied onto one surface of an aluminum foil haying an average thickness of 20 μm, sewing as the cathode collector, with a doctor blade. The average mass of the carbon active material in the applied cathode slurry after being dried was adjusted to 10.8 mg/cm². The foil having the dried cathode slurry thereon was punched into a circle having a diameter of 16 mm as a cathode.

The sodium-ion secondary battery obtained in Example 11 is a full cell because a carbonaceous material is used as the cathode active material. The sodium-ion secondary battery obtained in Example 11 was subjected to the following charge-discharge test for full cells.

### Charge-Discharge Test for Full Cells

The first charge and discharge were performed as a pretreatment (aging treatment) for the purpose of evenly impregnating the electrolytic solution into the electrode. Specifically, in the pretreatment (aging treatment), the battery was left to stand for 24 hours, charged to a charge final voltage of 5.0 V by constant-current charge, left to stand for 24 hours, and charged to a discharge final voltage of 3.0 V by constant-current discharge. After the aging treatment, the charge-discharge test was performed in the following manner.

During the charge and discharge, the current value was so adjusted that the current density became 0.3 A/g based on the weight of the anode active material.

[1]: Constant-current charge to 5.0 V with a current value having a current density of 0.3 A/g

[2]: Stop for 5 minutes

[3]: Constant-current charge to 3.0 V with a current value having a current density of 0.3 A/g

[4]: Stop for 5 minutes

After the charge-discharge test, discharge capacity was measured as battery capacity (mAh). The results are presented in Table 2. FIG. 5 is a graph showing a discharge curve obtained in Example 11.

In Example 11, a pre-doping treatment in which the anode is previously doped with sodium ion may be optionally performed. In the charge-discharge test for Example 11, since a carbonaceous material was used as the cathode active material, hexafluorophosphate (PF₆⁻) (anion) is inserted into the cathode active material and sodium ion (cation) is inserted into the anode active material when the voltage is 3.0 V or higher. Thus, the battery can be charged to provide a high capacity. In a case in which the pre-doping treatment is performed, the potential of the anode can be adjusted by controlling the pre-doping amount of sodium ion. Therefore, the potential of the anode is kept constant even when charge and discharge are repeated, thus improving cyclic performance.

The pre-doping treatment may involve bringing the anode into physical contact with a sodium metal foil to put them into a short circuit condition so that the anode is doped with sodium ion. Alternatively, before being involved in the battery, the anode may be subjected to an electrochemical doping in a nonaqueous electrolytic solution.

### Example 12

The procedure in Example 11 was repeated except for replacing the cathode active material (synthetic graphite) with another cathode active material (natural graphite Special CP available from Nippon Graphite Industries, Co., Ltd.) and changing the average mass per unit area of the cathode after being dried to 11.1 mg/cm². Thus, a sodium-ion secondary battery of Example 12 was prepared and evaluated in the same manner as in Example 11. The results are presented in Table 2.

### Example 13

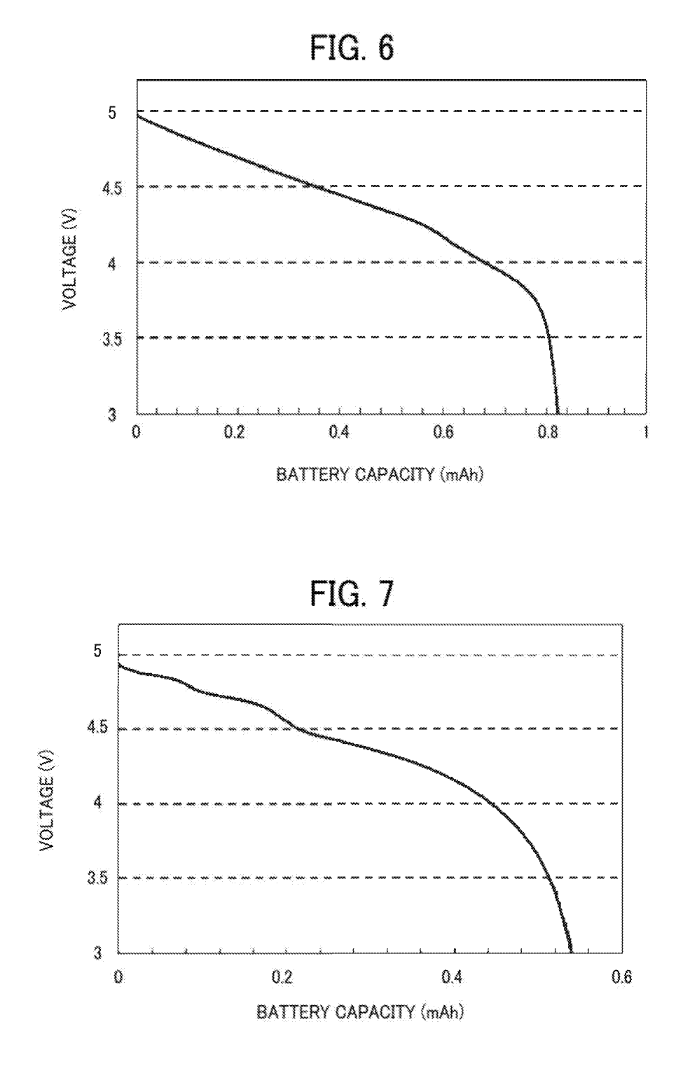

The procedure in Example 11 was repeated except for replacing the cathode active material (synthetic graphite) with another cathode active material (easily-graphitizable carbon obtained by burning a pulverized rare coke at 1,200° C. in an inert atmosphere) and changing the average mass per unit area of the cathode after being dried to 8.8 mg/cm². Thus, a sodium-ion secondary battery of Example 13 was prepared and evaluated in the same manner as in Example 11. The results are presented in Table 2. FIG. 6 is a graph showing a discharge curve obtained in Example 13

### Comparative Example 4

The procedure in Comparative Example 1. was repeated except for replacing the cathode with the other cathode used in Example 11. Thus, a sodium-ion secondary battery of Comparative Example 4 was prepared and evaluated in the same manner as in Comparative Example 1. The results are presented in Table 2.

### Comparative Example 5

The procedure in Comparative Example 2 was repeated except for replacing the cathode with the other cathode used in Example 11. Thus, a sodium-ion secondary battery of Comparative Example 5 was prepared and evaluated in the same manner as in Comparative Example 2. The results are presented in Table 2. FIG. 7 is a graph showing a discharge curve obtained in Comparative Example 5.

TABLE 2

| | | | | Example | Example | Example | Comparative | Comparative |
|---|---|---|---|---|---|---|---|---|
| | | | | 11 | 12 | 13 | Example 4 | Example 5 |
| Anode | Anode | Anode | Carbon Type | Carbon B | Carbon B | Carbon B | Natural | Poorly- |
| | Material | Active | | | | | Graphite | graphitizable |
| | | Material | | | | | | Carbon |
| | | | Three-dimensional | Yes | Yes | Yes | No | No |
| | | | Network Structure | | | | | |
| | | | Crystallinity | Yes | Yes | Yes | Yes | Yes |
| | | | Number of Peaks | 2 | 2 | 2 | 1 | 1 |
| | | | Bragg Angle 2θ (°) | 26.1 | 26.1 | 26.1 | 26.5 | 24.5 |
| | | | | 26.5 | 26.5 | 26.5 | | |
| | | | Intensity Ratio (Iₜ/Iₕ) | 1.2 | 1.2 | 1.2 | — | — |
| | | | Specific Surface | 90 | 90 | 90 | 10 | 8 |
| | | | Area (m²/g) | | | | | |
| | | | Volume of | 0.03 | 0.03 | 0.03 | — | — |
| | | | Micropores (mL/g) | | | | | |
| | | | Graphitization Degree | 0.55 | 0.55 | 0.55 | 0.05 | 1.00 |
| | | | Rₕ (I_{D}/I_{G}) | | | | | |
| | | Capacity of Active Material | | 798 | 798 | 798 | 16 | 337 |
| | | (mAh/g) | | | | | | |
| | | Amount of Active Material per | | 0.8 | 0.8 | 0.8 | 0.8 | 0.8 |
| | | Unit Area (mg/cm²) | | | | | | |
| | | Binder | | Styrene- | Styrene- | Styrene- | Styrene- | Styrene- |
| | | | | Butadiene | Butadiene | Butadiene | Butadiene | Butadiene |
| | | | | Rubber | Rubber | Rubber | Rubber | Rubber |
| | | Conductive Auxiliary Agent | | Acetylene | Acetylene | Acetylene | Acetylene | Acetylene |
| | | | | Black | Black | Black | Black | Black |
| | | Thickener | | Carboxy- | Carboxy- | Carboxy- | Carboxy- | Carboxv- |
| | | | | methyl | methyl | methyl | methyl | methyl |
| | | | | Cellulose | Cellulose | Cellulose | Cellulose | Cellulose |
| | Anode Collector | | Material | Copper | Copper | Copper | Copper | Copper |
| | | | | Foil | Foil | Foil | Foil | Foil |
| | | | Average Thickness | 18 | 18 | 18 | 18 | 18 |
| | | | (μm) | | | | | |
| Cathode | Cathode | Cathode Active Material | | Synthetic | Natural | Easily- | Synthetic | Synthetic |
| | Material | | | Graphite | Graphite | graphitizable | Graphite | Graphite |
| | | | | | | Carbon | | |
| | | Binder | | Acrylate- | Acrylate- | Acrylate- | Acrylate- | Acrytate- |
| | | | | based | based | based | based | based |
| | | | | Latex | Latex | Latex | Latex | Latex |
| | | Conductive Auxiliary Agent | | Acetylene | Acetylene | Acetylene | Acetylene | Acetylene |
| | | | | Black | Black | Black | Black | Black |
| | | Thickener | | Carboxy- | Carboxy- | Carboxy- | Carboxy- | Carboxy- |
| | | | | methyl | methyl | methyl | methyl | methyl |
| | | | | Cellulose | Cellulose | Cellulose | Cellulose | Cellulose |
| | | Capacity of Active Material | | 60 | 60 | 60 | 60 | 60 |
| | | (mAh/g) | | | | | | |
| | | Amount of Active Material per | | 10.8 | 11.1 | 8.8 | 10.8 | 10.8 |
| | | Unit Area (mg/cm²) | | | | | | |
| | Cathode Collector | | Material | Aluminum | Aluminum | Aluminum | Aluminum | Aluminum |
| | | | | Foil | Foil | Foil | Foil | Foil |
| | | | Average Thickness | 15 | 15 | 15 | 15 | 15 |
| | | | (μm) | | | | | |

| | | | | | | |
|---|---|---|---|---|---|---|
| Charge-Discharge Test | Voltage Range (V) | 3.0-5.0 | 3.0-5.0 | 3.0-5.0 | 3.0-5.0 | 3.0-5.0 |
| Conditions | | | | | | |
| Evaluation Results | Battery Capacity | 1.28 | 1.27 | 0.83 | 0.03 | 0.24 |
| | (mAh) | | | | | |

It is clear from Table 2 that, in Examples 11 to 13 in each of which a porous carbon having crystallinity and a plurality of pores forming a three-dimensional network structure inside is used as the anode active material, discharge capacity is higher than that in each of Comparative Examples 4 and 5, even when the secondary battery is a full cell using a carbonaceous material as the cathode. The discharge curves obtained in Example 11, Example 13, and Comparative Example 5 are shown in FIGS. 5, 6, and 7, respectively.

The discharge curve obtained in Example 11 shown in FIG. 5 has a plateau in the voltage range of 4.5 V or higher. When the synthetic graphite or natural graphite was used as the cathode active material, the discharge curve has a large plateau in the voltage range of 4.5 V or higher, thereby providing a high battery capacity. When a plateau is present in a higher voltage range, the average voltage of the battery becomes higher, which is advantageous for improving energy density of the battery. Accordingly, the cathode active material preferably includes at least one of natural graphite and synthetic graphite.

In accordance with some embodiments of the present invention, sodium-ion secondary batteries have been provided capable of occluding sodium ion in large amounts to provide a high capacity.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

1. A nonaqueous electrolytic solution storage element comprising
a cathode containing a cathode active material;
an anode containing an anode active material to which sodium ion is insertable and from which the sodium ion is separable, the anode active material comprising a porous carbon having a plurality of pores forming a three-dimensional network structure, the porous carbon having crystallinity; and
a nonaqueous electrolytic solution.

2. The nonaqueous electrolytic solution storage element of claim 1, wherein the plurality of pores includes micropores having a pore diameter less than 2 nm, and the micropores accounts for 0.01 to 0.30 mL/g of the anode active material.

3. The nonaqueous electrolytic solution storage element of claim 1, wherein the anode active material exhibits an X-ray diffraction spectrum having at least one diffraction peak within a Bragg angle 2θ range of from 25.00 to 27.00, when irradiated with X-ray.

4. The nonaqueous electrolytic solution storage element of claim 3, wherein the X-ray diffraction spectrum has two diffraction peaks within the Bragg angle 2θ range of from 25.00 to 27.00.

5. The nonaqueous electrolytic solution storage element of claim 4, wherein the two diffraction peaks include a lower-angle diffraction peak and a higher-angle diffraction peak, and a ratio (Iₗ/Iₕ) of an intensity Iₗ of the lower-angle diffraction peak to an intensity Iₕ of the higher-angle diffraction peak is greater than 1.

6. The nonaqueous electrolytic solution storage element of claim 1, wherein the anode active material exhibits a Raman spectrum having a peak P_{G} within a wavelength range of 1,580±100 cm⁻¹ and another peak P_{D} within a wavelength range of 1,360±100 cm⁻¹, when irradiated with laser light having a wavelength of 532 nm, wherein a graphitization degree (Rₕ), defined by a ratio (I_{D}/I_{G}) of an intensity (I_{D}) of the peak P_{D} to an intensity (I_{G}) of the peak P_{G}, ranges from 0.25 to 0.80.

7. The nonaqueous electrolytic solution storage element of claim 1, wherein the cathode active material includes at least one of natural graphite and synthetic graphite.

8. The nonaqueous electrolytic solution storage element of claim 1, wherein the nonaqueous electrolytic solution contains:
a nonaqueous solvent; and
an electrolyte salt including a sodium salt.

9. The nonaqueous electrolytic solution storage element of claim 8, wherein the sodium salt includes at least one of sodium hexafluorophosphate (NaPF₆) and sodium fluoroborate (NaBF₄).

10. The nonaqueous electrolytic solution storage element of claim 8, wherein a content of the electrolyte salt in the nonaqueous electrolytic solution ranges from 0.5 to 6 mol/L.
